(19) United States
(12) Patent Application Publication
(10) Pub. No.: US 2013/0006691 A1
(43) Pub. Date: Jan. 3, 2013

(54) Scheduling and payment systems and methods

(76) Inventors: Jill E. Arthur, Iowa City, IA (US); Lane Swenka, Coralville, IA (US)

(21) Appl. No.: 13/540,543

(22) Filed: Jul. 2, 2012

Related U.S. Application Data
(60) Provisional application No. 61/503,577, filed on Jun. 30, 2011.

(51) Int. Cl. G06Q 10/10

(52) U.S. Cl. 705/7.21

(57) ABSTRACT

The present systems and/or methods generally facilitate scheduling and/or payment of a service provider. In one embodiment, the scheduling system is integrated with a payment system and configured for use with childcare providers and childcare requestors (i.e., parents). In this embodiment the providers upload their schedules onto an online database via a website. The parents may then browse the available providers for a specific time and date at which the parents desire childcare services. The parents may select a specific time and date to create a booking request, which the website may then forward to the childcare provider. The childcare provider may accept the booking request, and the parent is notified of same. The parent may be billed for the services through the website and the childcare providers may be paid through the website so that no funds are exchanged directly between parents and childcare providers.

### CROSS REFERENCE TO RELATED APPLICATIONS

The present application claims priority from provisional U.S. Pat. App. No. 61/503,577 filed on Jun. 30, 2011, which is incorporated by reference herein in its entirety.

### FIELD OF INVENTION

The present invention relates to an internet-based scheduling and payment systems.

### STATEMENT REGARDING FEDERALLY SPONSORED RESEARCH OR DEVELOPMENT

No federal funds were used to develop or create the invention disclosed and described in the patent application.

### REFERENCE TO SEQUENCE LISTING, A TABLE, OR A COMPUTER PROGRAM LISTING COMPACT DISK APPENDIX

N/A

### AUTHORIZATION PURSUANT TO 37 C.F.R. §1.171 (d)

A portion of the disclosure of this patent document contains material which is subject to copyright and trademark protection. The copyright owner has no objection to the facsimile reproduction by anyone of the patent document or the patent disclosure, as it appears in the Patent and Trademark Office patent file or records, but otherwise reserves all copyrights whatsoever.

### TERMINOLOGY & DEFINITIONS

Before the various embodiments of the present invention are explained in detail, it is to be understood that the invention is not limited in its application to the details of construction and the arrangements of components set forth in the following description or illustrated in the drawings. The invention is capable of other embodiments and of being practiced or of being carried out in various ways. Also, it is to be understood that phraseology and terminology used herein with reference to device or element orientation (such as, for example, terms like “front”, “back”, “up”, “down”, “top”, “bottom”, and the like) are only used to simplify description of the present invention, and do not alone indicate or imply that the device or element referred to must have a particular orientation. In addition, terms such as “first”, “second”, and “third” are used herein and in the appended claims for purposes of description and are not intended to indicate or imply relative importance or significance. Furthermore, any terminology related to computer executable methods, web portals, web-based applications, and/or websites recited or called out herein are for exemplary purposes only and are not meant to limit the scope of the invention in any way unless so recited in the claims.

### DETAILED DESCRIPTION

Before the various embodiments of the present inventions are explained in detail, it is to be understood that the present invention is not limited in their application to the details of applications and/or parameters set forth in the following description or illustrated in the drawings. The present invention is capable of other embodiments and of being practiced or of being carried out in various ways. Operational parameters included herein are for illustrative purposes only, and in no way limit the scope of the present invention. The following detailed description is of the best currently contemplated modes of carrying out illustrative embodiments of the invention.

### Detailed Description of a General Scheduling and Payment System

The scheduling system generally includes at least one database onto which at least one provider may upload a time block. The database may be remotely accessed, such as via the internet. In one embodiment, the database resides on a server that may be accessed through a web portal (e.g., a web-based application), such as by using a computer, smart phone, or similar equipment. A requestor may access the database to view at least one time block uploaded to the database by a provider. It is contemplated that one embodiment of the scheduling system will include multiple time blocks from multiple providers. In such an embodiment, each provider and requestor will be provided with a unique username and password combination. The requestor may select an increment of a time block, or the entire time block. For example, if the provider has uploaded a time block of seven consecutive days onto the database, a requestor may select all seven days, one day, three days, and so on.

Once the requestor has selected an increment of a time block, the scheduling system automatically creates a booking request for the provider corresponding to that time block. The scheduling system may use a computer to generate the booking request, such as a sever. It is contemplated that the server on which the database resides may be programmed to generate the booking request, and that in one embodiment of the scheduling system and payment system as described herein, the scheduling and/or payment systems may be implemented as machine-readable methods such that the scheduling system and/or payment system may be implemented as a web-based computer application.

As part of creating the booking request, the scheduling system may alert the provider corresponding to the time block in which the booking request is found that a requestor has selected that specific increment of time. The scheduling system may alert the provider in any suitable manner, including but not limited to a telephone call, an electronic mail message, a wireless message, a text message, and/or any combinations thereof. When the scheduling system alerts the provider of the booking request, the scheduling system may give the provider many types of information, including but not limited to the time and date for which the requestor desires the provider's services, the address at which the requestor desires the provider's services, name and age of requestor, special comments about the services, contact information of the requestor such as phone number and email address, and/or combinations thereof.

After the provider has received the booking request, the provider may choose to accept or decline the booking request. If the provider accepts the booking request, the scheduling system may notify the requestor of same in any suitable manner, including but not limited to a telephone call, an electronic mail message, a wireless message, a text message, and/or any combinations thereof. If the provider declines the booking request, the scheduling system may notify the requestor of same in any suitable manner, including but not limited to a telephone call, an electronic mail message, a wireless message, a text message, and/or any combinations thereof. If the provider accepts the booking request, then the scheduling system may automatically update the database so that the period of time corresponding to the booking request is removed from the time block the provider previously uploaded.

One embodiment of the scheduling system shows pending booking requests on providers' schedules before the provider accepts or declines the booking request. Accordingly, other requestors will be able to see that a specific provider may not be available at a certain time, but will also have the option of viewing that provider's schedule at a later time to determine if the provider has accepted or declined the previously pending booking request and act accordingly. The scheduling system may include a search filter such that requestors may query all providers' time blocks on the database but view only certain results based on several factors, including but not limited to a specific provider or group of providers, provider location, preferred date of service, etc.

The scheduling system may be configured to allow a requestor to modify an accepted booking request. If the requestor chooses to modify an accepted booking request, the scheduling system 10 may be configured to alert the provider in any suitable manner, including but not limited to a telephone call, an electronic mail message, a wireless message, a text message, and/or any combinations thereof. The scheduling system may limit the window in which a requestor is allowed to modify an accepted booking request. For example, in one embodiment of the scheduling system the requestor may modify an accepted booking request any time up to two hours before the start of the booking request, after which time the booking request may not be changed. Such modifications include but are not limited to cancelling the booking request in its entirety and changing the date, time, and/or duration of the booking request. If a booking request is modified, the scheduling system may automatically notify the provider of same in any suitable manner, including but not limited to a telephone call, an electronic mail message, a wireless message, a text message, and/or any combinations thereof. The provider then arrives at the specified place at the specified time and date and provides the services asked for by the requestor.

The scheduling system may also be configured to include a messaging system via a web-based application. In such an embodiment, providers and requestors may be able to communicate with one another via electronic messages for certain reasons including but not limited to booking requests, time blocks, modifications, etc. Such an embodiment of a scheduling system may also be configured so that the provider or requestor will receive automatic notification when another party (i.e., provider or requestor) is attempting to communicate with that party via the web-based application. The scheduling system may automatically notify the provider of same in any suitable manner, including but not limited to a telephone call, an electronic mail message, a wireless message, a text message, and/or any combinations thereof.

The scheduling system may be configured to include a reminder function. For example, if a provider has accepted a booking request, the provider may indicate that the provider wishes to receive a reminder of the booking request at a predetermined time before the booking request is to begin (e.g., one week, one day, etc.). The same functionality may be provided to remind the requestor of a specific booking request, and both reminder functions may be set and/or adjusted by the provider and/or requestor via the web-based application.

The scheduling system may work in cooperation with a payment system. The payment system may be generally configured to compile each provider's wages for a given period of time (e.g., two weeks, one month, etc.) and disperse the appropriate wages at a specified time (e.g., the last day of the month, the fifteenth of each month, etc.). Additionally the payment system may be configured to compile each requestor's charges for a given period of time and add those charges to a billing statement. The payment system may work in tandem with the scheduling system and be accessible through the same channels and in the same manner such that the two systems are fully integrated with one another. For example, the payment system and scheduling system may be integrated into one computer program residing on a single machine that is accessible via a web-based computer application.

In conjunction with one embodiment of the scheduling system, the payment system may be configured to that the provider may adjust the duration, scope, and/or other parameters of a booking request after the completion thereof to create a completed booking request. For example, if time required to complete the services was longer than the requestor originally expected when the requestor made the booking request, the completed booking request may be configured to reflect that fact. Additionally, allowing the provider to create a completed booking request allows the provider and requestor to account for a change in scope of the services, which change in scope may require additional time not accounted for in the original booking request. For example, in certain situations the provider may account for travel time in a completed booking request.

The scheduling and payment systems may also be configured to allow the provider to create a personal notification for the requestor when the provider creates a completed booking request. The notification may include any pertinent data, including but not limited to notes related to any time adjustments in the booking request, personal messages, etc. The notification may also include a short questionnaire to solicit feedback of any kind, including but not limited to feedback relating to the specific provider and/or the scheduling system.

The payment system may then add the hours in the completed booking request to the wages payable to that particular provider, and add those hours to the charges accrued to the particular requestor in that requestor's billing statement. The payment system may be configured so that the rate of the provider is determined before the requestor makes a booking request. The provider's pay may be based on any acceptable increment, including by not limited to hourly, weekly, monthly, and/or on a per-project basis. Additionally, the provider's pay may be different at different times of a booking request, depending on the services and/or embodiment of the scheduling system. Predetermining the provider's payment for a specific booking request and integrating the scheduling system with the payment system allows all funds to be exchanged electronically after the provider has created a completed booking request rather than physically between the requestor and provider at the location at which the provider performs the services. Furthermore, a portion of the provider's rate may be withheld for other purposes, including but not limited to overhead, profit, insurance, and/or combinations thereof.

A requestor may be invoiced at any time for the charges accrued in the requestor's billing statement, although it is contemplated that it will be most convenient to invoice the requestors on a bi-weekly or monthly basis, which invoicing the scheduling and payment systems may perform automatically. For example, the scheduling and payment systems may be configured to deliver an electronic invoice to each requestor in any suitable manner, including but not limited to a telephone call, an electronic mail message, a wireless message, a text message, and/or any combinations thereof. The scheduling and payment systems may be configured to then automatically deduct that invoice amount from a bank account on file, charge a credit card on file, or collect the invoice amount in any other suitable manner. Additionally, the payment system may automatically add a processing fee to each invoice to account for other costs, including but not limited to credit card processing fees, administration, office personnel, and/or combinations thereof.

One embodiment of the scheduling system may also allow requestors to create long-term booking requests. In a long-term booking request, the requestor asks a specific provider to commit to a consist schedule. The requestor may create a long-term booking request in a similar manner to which the requestor creates a booking request, which may or may not include specific hours for each date in the long-term booking request. If the long-term booking request does not include specific hours for each date, and the provider accepts the request, then each date in the request will be communicated to both the requestor and provider. Each individual date within the long-term booking request may then be modified or canceled in the manner previously described for regular booking requests. Accordingly, long-term booking requests mitigate any scheduling problems that may arise when a provider has committed to perform services for a specific requestor on a regular or semi-regular basis, but the requestor knows only the approximate times for those services. The time basis for long-term booking requests may be weekly, monthly, yearly, or any other increment that is suitable for the particular services.

One embodiment of the scheduling system may also include introduction requests. In such an embodiment instead of creating a booking request, the requestor may create an introduction request for a specific provider. The provider may be notified about the introduction request in the same manner as the provider is notified of a booking request. The introduction request may give the provider the same or different information as a booking request, which may include but is not limited to the requestor's preferred contact method. The requestor and provider may then coordinate to meet one another so that the requestor may personally approve the provider prior to the provider performing any services for the requestor.

One embodiment of the scheduling system includes a payment system that may also include referral credits. In such an embodiment a requestor may refer another potential requestor to the scheduling system (in one embodiment the referral is achieved via sharing the URL for the web-based application that provides the graphic user interface for the scheduling and/or payment systems). When registering for access to the scheduling and/or payment systems, the referred requestor may indicate the name of the referring requestor. The payment system may then automatically credit the referring requestor's account by a certain amount, which may appear as a credit on that requestor's next invoice.

The scheduling and/or payment systems may also include a revocation policy for any requestor and/or provider for any reason. For example, in one embodiment a provider's access to the scheduling and/or payment systems may be revoked upon the provider's cancellation of a certain number of booking requests.

### Detailed Description of a Childcare Embodiment of a Scheduling and Payment System

One specific embodiment of a scheduling and payment system for childcare services will now be described. In this embodiment, the scheduling and payment system is configured to be deployed via a computer (e.g., mainframe, server, etc.) that is accessible via a web portal configured as a website. However, this description is in no way limits the scope of the scheduling system and/or or payment system and is simply intended to better illustrate the broader concepts disclosed and claimed herein.

In an embodiment of the scheduling and payment systems configured for use with childcare, the providers may be childcare providers and the requestors may be individuals and/or families desiring childcare. First, suitable childcare providers may be selected through a vetting process, which may include background checks, credit checks, personal referrals, etc. to determine whether an individual is a suitable childcare provider. The childcare provider may be required to sign an agreement specifying certain terms for conduct, behavior, etc., which agreement may also specify that the childcare providers are independent contractors rather than employees of an entity maintaining the scheduling and/or payment systems.

After a suitable childcare provider has been identified, the childcare provider may be granted access to a website onto which the childcare provider may upload a block or blocks of time during which the childcare provider is available to perform childcare services. The childcare provider may be required to agree to certain terms and conditions to access and use the website.

Additionally, childcare providers may need to provide personal information to use the website, such as address, name, birth date, social security number, etc. Each childcare provider may receive a unique username and password to allow multiple childcare providers to upload their schedules onto the website. It is contemplated that childcare providers will be screened and interviewed prior to granting them access website. Additionally, it is contemplated that the website will allow childcare providers to create personal profiles on the website that may include but is not limited to pictures, videos, qualifications, personal info, and/or contact information. The website may allow childcare providers to continually modify available hours (i.e., blocks of time). The website may also allow childcare providers to upload certain blocks of time for certain geographic areas. For example, if the childcare provider is a college student attending a college in a first city, the childcare provider may upload a first plurality of blocks of time specifically for that first city and a second plurality of blocks of time for a second city that is the childcare provider's hometown to accommodate holidays and the like.

Parents (i.e., requestors) may register at the same website to view the schedules of the childcare providers in one or more geographic areas. Parents may be required to agree to certain terms and conditions to access and use the website. Additionally, parents may need to provide personal information to use the website, such as address, name, birth date, social security number, credit card information, etc. Once a parent has properly registered to use the website, the parent may view the schedules that the childcare providers have uploaded. The website may display the hours that various childcare providers are available in any suitable manner. For example, parents may choose a specific childcare provider and view all hours in which that childcare provider is available. Alternatively, parents may choose a specific date and view all childcare providers that are available on that date. The parent may then select a specific childcare provider for a specific time to create a booking request. The website may then be configured to automatically alert the childcare provider of the booking request via an email, telephone call, text message, etc. The alert may also include the names of the parents and children, the address of the parents, the ages of the children, and/or the time and date of the booking request.

After the childcare provider receives the booking request, the childcare provider may either accept or decline it through logging into the website. The website may automatically alert the parent to the childcare provider's choice either way via text message, email, telephone, etc. If the childcare provider has declined the booking request, the parent may then select the same time and date for a different childcare provider whose schedule indicates availability. The alert the parent receives when a childcare provider declines a booking request may also include contact information for a manager or administrator overseeing the scheduling and payment systems for that specific geographic area.

If the childcare provider has accepted the booking request, the parent may modify the booking request before the booking request starts. In some embodiments the website will allow modification of booking request only up to a certain time before the booking request is scheduled to start, such as up to 30 minutes before the start time. If the parent modifies the booking request, the website automatically alerts the childcare provider of the modification via an email, telephone call, text message, etc. The alert may also include an explanation of the reason for modification. The website may be configured to automatically prompt a childcare provider to either delete the hours of availability in a time block(s), update, and/or change the hours of availability depending on whether the childcare provider has accepted or declined the booking request, or if other circumstances have arisen.

The website may also indicate that a booking request is pending for a specific childcare provider during the time between the moment the parent creates the booking request but before the childcare provider has either accepted or declined it. Accordingly, other parents will be able to see that a specific childcare provider may not be available at a certain time, but other parents will also have the option of viewing that childcare provider's schedule at a later time to determine if the childcare provider has accepted or declined the previously pending booking request and act accordingly (i.e., look for another childcare provider that is available during that time or create their own booking request for the childcare provider who previously had a pending booking request during the desired time but subsequently declined it).

As described above, certain embodiments of the scheduling system include the ability for requestors to create long-term booking requests. In a childcare embodiment of the scheduling system, the website may provide a link keyed to a specific childcare provider for creating a long-term booking request. When creating a long-term booking request, the parent may indicate, among other things, the recurring days of the week, approximate duration, approximate times on each day, number of children, and add any special comments. The website may then automatically notify that specific childcare provider of the long-term booking request as previously described for regular booking requests. If the childcare provider accepts the long-term booking request, then the childcare provider may appear unavailable to other parents on the dates specified in the request. Additionally, on the parent's account on the website the dates appear as accepted booking requests for that specific childcare provider. Each individual date within the long term booking request may then be modified or canceled in the manner previously described for regular booking requests. Accordingly, one function of long-term booking requests is to mitigate any scheduling problems that may arise due to a childcare provider appearing available on the website to other parents when in fact that childcare provider is not available. The time basis for long-terms booking requests may be weekly, monthly, yearly, or any other increment that is suitable for the particular services.

A childcare embodiment of the scheduling and payment systems may also include an introduction request, as previously described. In the childcare embodiment, such functionality may be implemented by allowing parents to create introduction requests for specific childcare providers. The website may then automatically notify the childcare provider about the introduction request in the same manner as the childcare provider is notified of a booking request. The introduction request may give the childcare provider the same or different information as a booking request, which may include but is not limited to the parent's name and address, number of children, contact information, and/or preferred contact method. The parent and childcare provider may then coordinate to meet one another so that the parent may personally approve the childcare provider prior to the childcare provider performing any services for the parent.

A childcare embodiment of the scheduling and payment systems may also include the ability for parents to create booking requests that include overnight hours. It is contemplated that the rates for overnight hours may be different for daytime hours, and that a booking request that includes overnight hours will be adjusted accordingly upon predetermined conditions. For example, in one embodiment the hours between 10pm and 7am the next day may be considered overnight hours and therefore have a different charge associated therewith than hours between 7:01am and 9:59pm on the same day. Alternatively, the adjustment for different rates may be done in the completed booking request. The booking requests may allow a childcare provider to indicate whether he/she is able to provide tutoring during specified hours of childcare, which may also have a different rate associated therewith.

A childcare embodiment of the scheduling and payment systems may also include the ability for parents to create a transport booking request. It is contemplated that this will primarily be used by parents of children whose children do not need supervision while at home, but whose children do not have a license to drive. A transport booking request may include (in addition to the information previously described for a regular booking request) the pick-up and drop off times and locations. It is contemplated that different charges will apply to transport requests, and that the charges may be calculated differently or in addition to other childcare service charges.

A childcare embodiment of the scheduling and payment systems may also include the ability for parents to create a last-minute booking request. In this situation, the website may allow the parent to indicate that the booking request is a last-minute booking request (for example, by checking a box on the website during the creation of the booking request). Designating a booking request as a last-minute booking request may require the childcare provider to accept or decline the booking request via telephone, text message, or other expedient mode of communication.

In this embodiment, the childcare provider arrives at the specified location on the specified date at the specified time (all of which data is dependent on the booking request). The childcare provider then completes the services (i.e., watching the parent's children). The childcare provider may then log onto the website and change the booking request to a completed booking request. At this point, the childcare provider may be allowed to adjust the duration of the booking request to accurately reflect the amount of time the childcare provider was watching the parent's children. The adjustment may also account for travel time to and from the childcare location. Additionally, the provider may adjust the total charges in the completed booking request due to changes in the number of children present for certain hours of the booking request. For example, the booking request may indicate that two children will be present from 8am to 5pm—the entire booking request. However, during the performance of the childcare services, an additional child may arrive home from school at 3pm, for example, such that for two hours of the booking request three children are present. The scheduling and payment methods may allow the childcare provider to account for this in the completed booking request.

The childcare provider may also include a personal note to the parent in the completed booking request. Once the provider has created completed booking request, the website may automatically alert the parent that the specific booking request has been completed. This may be done via an email, telephone call, text message, etc. This alert may also notify the parent as to the amount charged to the parent's account due to the completed booking request, and the total charges accrued to the parent's account since the last invoice. The alert may also give the parent a method to ask questions as to any discrepancies between the booking request and the completed booking request. Finally, the alert may include a short survey and/or questionnaire. The subject matter of the survey and/or questionnaire may include but is not limited to the specific childcare provider and quality if his/her service, childcare preferences, the website, and general information related to parenting or children. The website may forward the survey results to an area manager, supervisor, or administrator of the scheduling and payment system. Parents may also have the ability to make notes on their account for reminders related to specific childcare providers (e.g., “Jane was very good with our toddlers,” or “Jane cleaned the kitchen during her shift”).

The website may indicate to parents the cost for each childcare provider on any reasonable basis, including but not limited to per hour or per job. Furthermore, the cost may be different depending on the number of children the childcare provider is required to watch. For example, the cost may be $9/hour for one child, $10/hour for two children, and $11/hour for three or more children. However, the costs may change on different dates and/or be dependent on geographic location. For example, the cost per hour may be higher on holidays or on days when local events of import occur. It is contemplated that each childcare provider's calendar may have a color code to indicate days on which the costs are other than what the normal costs would be. The website may automatically tally the charges for a given parent's account since the last payment the parent made. The website may also automatically tally the wages accrued for a given childcare provider since the last payment sent to the childcare provider.

The website may automatically generate an invoice to all registered parents at a predetermined time (e.g., weekly, monthly, etc.) or upon a predetermined condition (e.g., accrued wages are greater than a certain amount). The website may also automatically generate a payment to the childcare provider at a predetermined time (e.g., weekly, monthly, etc.) or upon a predetermined condition (e.g., accrued wages are greater than a certain amount). The set pricing and automatic invoicing for parents and automatic payment for childcare providers eliminates the awkwardness for parents in determining how much to pay the childcare provider and the awkwardness for the childcare provider in collecting money after performing the childcare services. Furthermore, the automatic invoicing and payment are more convenient for both the parents and the childcare providers. The website may be configured to store a certain number of previous invoices for easy retrieval, review, and/or printing by parents, and it may store a certain number of wage statements for easy retrieval, review and/or printing by childcare providers.

The website may also automatically update all childcare providers' hours at a specific time. For example, on the first day of a month, the website may automatically clear all booking requests for the previous month that have no correlating completed booking request. In such an embodiment, the website may automatically notify all childcare providers and/or parents that all booking requests need to have a correlating completed booking request created within a specific time (e.g., within the next 24 hours) or the hours accountable to booking requests without correlating completed booking requests will not be paid to the corresponding childcare providers. This notification may be made in any suitable manner, including but not limited to a telephone call, an electronic mail message, a wireless message, a text message, and/or any combinations thereof. Alternatively, the website may automatically roll over booking requests for the previous month that have no correlating completed booking request into the next month.

The website employing the scheduling and/or payment systems may also include a referral system for parents. For example, when a parent registers on the website for the first time, the parent may be presented with the opportunity to enter the name and/or other information about the party who referred him/her. The website may then automatically credit the referring parent's account by a specific amount (e.g., one free hour of childcare).

It is contemplated that a portion of each childcare provider's payments may be reserved so as to create a stream of revenue for the entity that maintains the website. This may be a percentage of the overall payments or a monthly fee for granting parents and/or childcare providers access to the website. Additionally, it is contemplated that the entire scheduling and payment systems may be completely automated, such that both systems may be computer-executable methods accessible as web-based applications. Alternatively, other means may be used within the scope of the present systems and/or methods. For example, a wide area network (WAN) may be established between providers and requestors, or different mobile computing technology may be used.

The website may also be configured to include an administrator interface that is accessible only to authorized individuals. The administrator interface may allow those individuals to review all childcare providers, registered parents, booking requests, and/or completed booking requests for specific childcare provides and/or a specific geographic area. The administrator interface may allow authorized individuals to: (1) create booking requests and/or completed booking requests and/or modify same on behalf of parents; (2) send mass communications (e.g., electronic mail, text messages, etc.) to specific parents, childcare providers, and/or groups of parents and/or groups of childcare providers with specific information (e.g., updates, announcements, etc.); (3) change rates for childcare services; (4) view and respond to parent and/or childcare provider surveys; (5) deactivate childcare provider accounts or add new childcare provider accounts; (6) view financial information for specific time period related to specific geographic area; (7) organize childcare providers and parents seeking long-term booking requests; (8) organize which parents provide a good fit for which childcare providers; (9) organize childcare providers based on survey feedback (e.g., rewards for certain positive reviews, penalties for negative reviews); and/or (10) organize parent accounts based on registration date and/or other factors (e.g., average hours purchased per month, average completed booking request duration).

### Detailed Description of an Eldercare Embodiment of a Scheduling and Payment System

One specific embodiment of a scheduling and payment system for eldercare services will now be described. However, this description is in no way limiting and is simply intended to better illustrate the broader concepts disclosed herein.

An eldercare embodiment of a scheduling and payment system may be configured in substantially the same manner as the childcare embodiment previously described. However, in this embodiment the provider would be an eldercare provider, and the requestor would be an individual seeking eldercare rather than childcare. Eldercare providers may be granted access to the website to upload available times, and requestors could be granted access to the website to create booking requests for specific eldercare providers.

Rates for various services may be predetermined in a manner similar to that described for the childcare embodiment. These rates may be an hourly charge, based on the services the eldercare provider will perform, or based on some other metric. Accordingly, the requestor payment and the provider wages may be entirely automated.

### Detailed Description of a Lawncare Embodiment of a Scheduling and Payment System

One specific embodiment of a scheduling and payment system for lawn care services will now be described. However, this description is in no way limiting and simply intended to better illustrate the broader concepts disclosed herein.

A lawn care embodiment of a scheduling and payment system may be configured in substantially the same manner as the childcare embodiment previously described. However, in this embodiment the provider would be a lawn care provider, and the requestor would be an individual seeking lawn care rather than childcare. Lawn care providers may be granted access to the website to upload available times, and requestors could be granted access to the website to create booking requests for specific lawn care providers.

Rates for various services may be predetermined in a manner similar to that described for the eldercare embodiment. Accordingly, the requestor payment and the provider wages may be entirely automated.

This scheduling and payment system may be used for any type of services, including but not limited to tutoring, companionship, mentoring, general household chores, cleaning, maintenance, auto repair, painting, medical care, and/or combinations thereof. Accordingly, the specific embodiments disclosed herein are in no way limiting to the scope of the scheduling system and/or payment system.

The preceding constraints, examples, and configurations in any of the embodiments disclosed and described herein are for illustrative purposes only, and are in no way limiting to the scope of any of the systems and/or methods as disclosed and claimed herein. Furthermore, the various solutions, processes, methods, modules, web-based applications, websites, and/or embodiments disclosed or described herein may be implemented in conjunction with one another or independently from one another. Accordingly, the presence or absence of other subject matter that may be complementary to the present systems and/or methods in no way limits the scope of the present systems and/or methods.

It should be noted that the present systems and/or methods are not limited to the specific embodiments described herein, but is intended to apply to all similar systems and/or methods for scheduling a service provider and/or making payment to a service provider. Modifications and alterations from the described embodiments will occur to those skilled in the art without departure from the spirit and scope of the present systems and/or methods.

1. A scheduling method comprising:
a. providing a database onto which a provider may upload a time block, wherein said database may be remotely accessed;
b. allowing a requestor to view said time block;
c. said requestor selecting an increment of said time block so as to create a booking request;
d. alerting said provider of said booking request;
e. said provider accepting said booking request;
f. alerting said requestor of said provider's acceptance of said booking request; and,
g. said provider performing a certain task during said booking request.

2. The scheduling method according to claim 1 further comprising a payment method, said payment method comprising the steps:
a. allowing said provider to input an actual duration of said booking request into said database after said provider has performed said certain task;
b. said provider denoting in said database that said booking request is complete;
c. adding said actual duration to a record keyed to said provider; and,
d. adding said actual duration to a record keyed to said requestor.

3. The scheduling method according to claim 2 wherein said payment method further comprises the step of verifying said actual duration with said requestor after the step of said provider denoting in said database that said booking request is complete.

4. The scheduling method according to claim 3 wherein the alerting step further comprises indicating to said provider the name, address, phone number, and email address of said requestor.

5. The scheduling method according to claim 1 wherein said method further comprises the step of updating said time block after said provider accepts said booking request.

6. The scheduling method according to claim 1 wherein said method further comprises the step of said requestor cancelling said booking request after said requestor has been alerted of said provider's acceptance.

7. The scheduling method according to claim 2 wherein said method further comprises the step of notifying said requestor after the step of adding said actual duration to a billing statement keyed to said requestor.

8. A method of generating income, said method comprising the steps of:
a. providing a database onto which a provider may upload a time block, wherein said database may be remotely accessed;
b. allowing a requestor to view said time block;
c. said requestor selecting an increment of said time block so as to create a booking request;
d. alerting said provider of said booking request;
e. said provider accepting said booking request;
f. alerting said requestor of said provider's acceptance of said booking request;
g. said provider performing a certain task during said booking request;
h. allowing said provider to input an actual duration of said booking request into said database after said provider has performed said certain task;
i. said provider denoting in said database that said booking request is complete;
j. adding said actual duration to a record keyed to said provider;
k. adding said actual duration to a billing statement keyed to said requestor; and,
l. retaining a specific portion of said billing statement.
